(19) United States
(12) Patent Application Publication
(10) Pub. No.: US 2025/0342596 A1
(43) Pub. Date: Nov. 6, 2025

(54) IMAGE PROCESSING DEVICE, OPERATION METHOD OF IMAGE PROCESSING DEVICE, AND OPERATION PROGRAM OF IMAGE PROCESSING DEVICE

(71) Applicant: FUJIFILM Corporation, Tokyo (JP)

(72) Inventor: Masashi KURANOSHITA, Saitama-shi (JP)

(73) Assignee: FUJIFILM Corporation, Tokyo (JP)

(21) Appl. No.: 19/265,950

(22) Filed: Jul. 10, 2025

Related U.S. Application Data
(63) Continuation of application No. PCT/JP2023/041148, filed on Nov. 15, 2023.

(30) Foreign Application Priority Data
Jan. 20, 2023 (JP) 2023-007610

(51) Int. Cl. G06T 7/11; G06T 7/00

(52) U.S. Cl. CPC G06T 7/11; G06T 7/0002; G06T 2207/20132; G06T 2207/30168

(57) ABSTRACT

An image processing device includes: a processor, in which the processor is configured to: obtain an evaluation value for a quality of an image; and determine a trimming method of a trimming target image, which is any one of the image or a related image of the image, based on the evaluation value.

### CROSS-REFERENCE TO RELATED APPLICATIONS

This application is a continuation application of International Application No. PCT/JP2023/041148, filed Nov. 15, 2023, the disclosure of which is incorporated herein by reference in its entirety. Further, this application claims priority from Japanese Patent Application No. 2023-007610, filed on Jan. 20, 2023, the disclosure of which is incorporated herein by reference in its entirety.

### BACKGROUND

### 1. Technical Field

The technology of the present disclosure relates to an image processing device, an operation method of an image processing device, and an operation program of an image processing device.

### 2. Description of the Related Art

JP2018-014653A discloses an image processing device including a detection unit that detects a plurality of subjects from an image, a setting unit that sets a plurality of coordinates for disposing the subject, a determination unit that determines, in a case in which there is one subject, a trimming region such that the subject is located at a predetermined coordinate of the image, and that obtains, in a case in which there are a plurality of subjects, evaluation values for the plurality of subjects based on a distance from the predetermined coordinate, to determine a trimming region based on the evaluation values for the plurality of subjects, and a trimming unit that trims the image in accordance with the calculated trimming region.

### SUMMARY

One embodiment according to the technology of the present disclosure provides an image processing device, an operation method of an image processing device, and an operation program of an image processing device, which are capable of more easily determining an appropriate trimming method.

The present disclosure relates to an image processing device comprising: a processor, in which the processor is configured to: obtain an evaluation value for a quality of an image; and determine a trimming method of a trimming target image, which is any one of the image or a related image of the image, based on the evaluation value.

It is preferable that the processor is configured to: use a machine learning model that outputs the evaluation value in response to input of the image.

It is preferable that the machine learning model has been trained using a plurality of training data composed of a set of the image and the evaluation value given by a user for the image.

It is preferable that the processor is configured to: acquire at least one of attribute information of a user who owns the trimming target image, accessory information of the trimming target image, or specification information of a photo album created using the trimming target image; and determine the trimming method of the trimming target image based on at least one of the attribute information, the accessory information, or the specification information, in addition to the evaluation value.

It is preferable that the processor is configured to: determine not to trim the trimming target image in a case in which the evaluation value is equal to or more than a first threshold; determine to perform first trimming in which a proportion of an area occupied by a main subject is to be less than a third threshold multiple of a proportion before trimming in a case in which the evaluation value is equal to or more than a second threshold and less than the first threshold; and determine the trimming method based on at least one of the attribute information, the accessory information, or the specification information in a case in which the evaluation value is less than the second threshold.

It is preferable that the processor is configured to: determine to perform any one of the first trimming or second trimming in which the proportion is increased to be equal to or more than the third threshold multiple of the proportion before trimming in accordance with at least one of the attribute information, the accessory information, or the specification information in a case in which the evaluation value is less than the second threshold.

It is preferable that the processor is configured to: determine not to trim the trimming target image in a case in which the evaluation value is equal to or more than a fourth threshold; determine to perform third trimming in which a proportion of an area occupied by a main subject is to be less than a sixth threshold multiple of a proportion before trimming in a case in which the evaluation value is equal to or more than a fifth threshold and less than the fourth threshold; and determine to perform fourth trimming in which the proportion is increased to be equal to or more than the sixth threshold multiple of the proportion before trimming in a case in which the evaluation value is less than the fifth threshold.

It is preferable that the image is a plurality of images belonging to a designated user, the related image, which is the trimming target image, is one of the plurality of images, and the processor is configured to: obtain the evaluation values from the plurality of images; and determine the trimming method of the trimming target image based on a representative value of a plurality of the evaluation values obtained from the plurality of images.

The present disclosure relates to an operation method of an image processing device, the operation method comprising: obtaining an evaluation value for a quality of an image; and determining a trimming method of a trimming target image, which is any one of the image or a related image of the image, based on the evaluation value.

The present disclosure relates to an operation program of an image processing device, the operation program causing a computer to execute a process comprising: obtaining an evaluation value for a quality of an image; and determining a trimming method of a trimming target image, which is any one of the image or a related image of the image, based on the evaluation value.

### BRIEF DESCRIPTION OF THE DRAWINGS

Exemplary embodiments according to the technique of the present disclosure will be described in detail based on the following figures, wherein:

FIG. 1 is a diagram showing a user terminal and an image management server;

FIG. 2 is a block diagram showing computers constituting the user terminal and the image management server;

FIG. 3 is a block diagram showing processing units of a CPU of the user terminal;

FIG. 4 is a block diagram showing processing units of a CPU of the image management server;

FIG. 5 is a diagram showing data stored in an image DB;

FIG. 6 is a diagram showing accessory information;

FIG. 7 is a diagram showing processing of each processing unit of the image management server in a case in which an image storage request is transmitted from the user terminal;

FIG. 8 is a diagram showing an image editing screen;

FIG. 9 is a diagram showing processing of each processing unit of the image management server in a case in which an automatic trimming request is transmitted from the user terminal;

FIG. 10 is a diagram showing a detailed configuration of an image editing unit;

FIG. 11 is a diagram showing an aspect in which a probability that a trimming target image is used in a photo album is calculated using a usage probability calculation model;

FIG. 12 is a diagram showing an outline of processing in a training phase of the usage probability calculation model;

FIG. 13 is a flowchart showing a processing procedure of an automatic trimming unit;

FIG. 14 is a diagram showing a determination rule;

FIG. 15 is a diagram showing an aspect in which first trimming is performed using a first trimming model;

FIG. 16 is a diagram showing an aspect in which second trimming is performed using a second trimming model;

FIG. 17 is a diagram showing an outline of processing in a training phase of the first trimming model;

FIG. 18 is a diagram showing an outline of processing in a training phase of the second trimming model;

FIG. 19 is a diagram showing an automatic trimming result display screen;

FIG. 20 is a flowchart showing a processing procedure of the image management server;

FIG. 21 is a diagram showing an aspect in which a probability that the trimming target image is shortlisted for a photo contest is calculated using a shortlist probability calculation model;

FIG. 22 is a diagram showing an outline of processing in a training phase of the shortlist probability calculation model;

FIG. 23 is a diagram showing an aspect in which a theme of the photo album and an image to be used in the photo album are selected on an album creation screen;

FIG. 24 is a diagram showing an aspect in which a layout of the photo album is selected on the album creation screen;

FIG. 25 is a diagram showing a creation request for the photo album;

FIG. 26 is a diagram showing a determination rule of Modification Example 2;

FIG. 27 is a flowchart showing a processing procedure of an automatic trimming unit according to a second embodiment;

FIG. 28 is a diagram showing processing of an automatic trimming unit according to a third embodiment;

FIG. 29 is a diagram showing processing of an automatic trimming unit according to a fourth embodiment;

FIG. 30 is a flowchart showing a processing procedure of an automatic trimming unit according to a fifth embodiment; and

FIG. 31 is a flowchart showing a processing procedure of an automatic trimming unit of a fifth embodiment.

### DETAILED DESCRIPTION

### First Embodiment

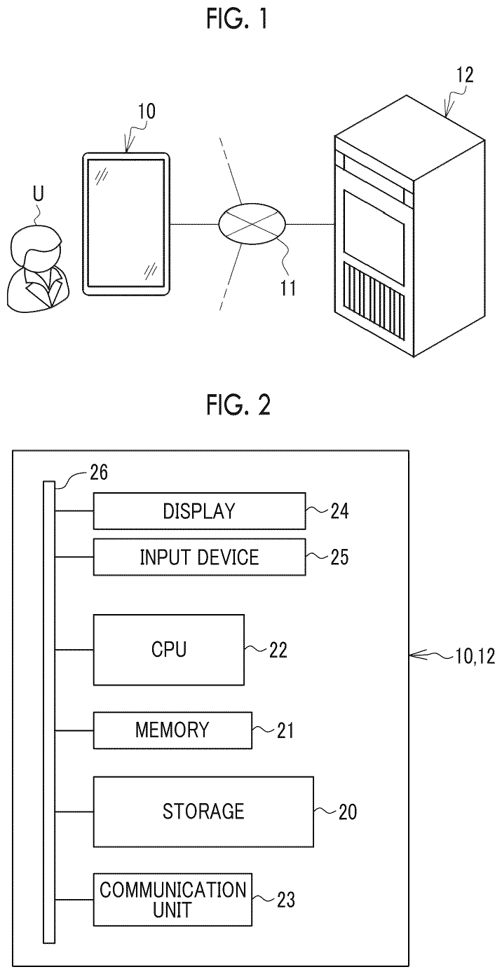

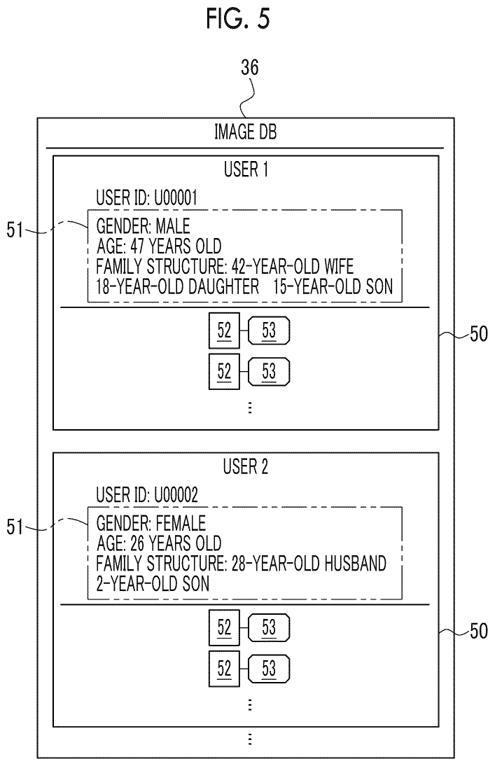

As an example, as shown in FIG. 1, a user U owns a user terminal 10. The user terminal 10 is a device having a camera function, an image reproduction display function, an image editing function, an image transmission/reception function, and the like. The camera function of the user terminal 10 has an imaging element such as a complementary metal-oxide-semiconductor (CMOS) image sensor, and obtains an image 52 (see FIG. 5) of a subject by forming an image of subject light, which is taken in from a lens, on the imaging element. Specifically, the user terminal 10 is a smartphone, a tablet terminal, a compact digital camera, a mirrorless single-lens camera, a laptop personal computer, and the like. The user U captures the image 52 by using the camera function or edits the image 52 to the personal preference by using the image editing function.

The user terminal 10 is connected to an image management server 12 via a network 11 such that the user terminal 10 and the image management server 12 can communicate with each other. The network 11 is, for example, a wide area network (WAN), such as the Internet or a public communication network. The user terminal 10 transmits (uploads) the image 52 to the image management server 12. In addition, the user terminal 10 receives (downloads) the image 52 from the image management server 12.

The image management server 12 is, for example, a server computer, a workstation, or the like, and is an example of an “image processing device” according to the technology of the present disclosure. A plurality of the user terminals 10 of a plurality of the users U are connected to the image management server 12 via the network 11.

As shown in FIG. 2 as an example, computers constituting the user terminal 10 and the image management server 12 basically have the same configuration, and comprise a storage 20, a memory 21, a central processing unit (CPU) 22, a communication unit 23, a display 24, and an input device 25. These units are connected to each other through a busline 26.

The storage 20 is a hard disk drive that is built in the computers constituting the user terminal 10 and the image management server 12 or is connected to the computers through a cable or a network. Alternatively, the storage 20 is a disk array in which a plurality of hard disk drives are mounted in series. A control program such as an operating system, various application programs (hereinafter, abbreviated as AP), various data associated with these programs, and the like are stored in the storage 20. It should be noted that a solid state drive may be used instead of the hard disk drive.

The memory 21 is a work memory for the CPU 22 to execute processing. The CPU 22 loads the program stored in the storage 20 into the memory 21, and executes processing in accordance with the program. As a result, the CPU 22 integrally controls the respective units of the computer. The CPU 22 is an example of a “processor” according to the technology of the present disclosure. It should be noted that the memory 21 may be built in the CPU 22.

The communication unit 23 is a network interface that performs control of transmitting various types of information via the network 11 and the like. The display 24 displays various screens. The various screens have an operation function using a graphical user interface (GUI). The computers constituting the user terminal 10 and the image management server 12 receive input of an operation instruction from the input device 25 through various screens. The input device 25 is, for example, a keyboard, a mouse, a touch panel, and a microphone for voice input.

It should be noted that, in the following description, the respective units (the storage 20, the CPU 22, the display 24, and the input device 25) of the computer constituting the user terminal 10 are distinguished by adding a subscript “A” to the reference numerals thereof, and the respective units (the storage 20 and the CPU 22) of the computer constituting the image management server 12 are distinguished by adding a subscript “B” to the reference numerals thereof.

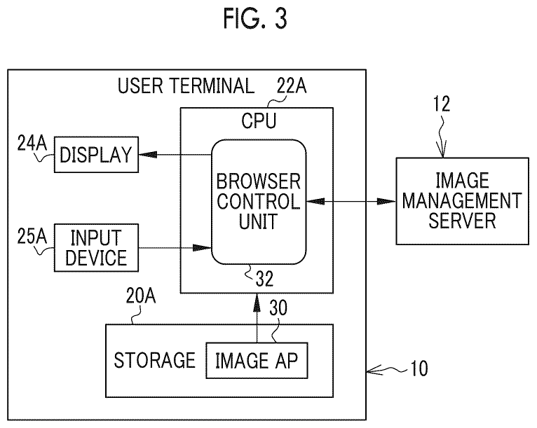

As shown in FIG. 3 as an example, an image AP 30 is stored in the storage 20A of the user terminal 10. The image AP 30 is installed in the user terminal 10 by the user U. The image AP 30 is an AP for reproducing and displaying or editing the image 52 on the user terminal 10. In a case in which the image AP 30 is activated, a CPU 22A of the user terminal 10 functions as a browser control unit 32 in cooperation with the memory 21 and the like. The browser control unit 32 controls the operation of the dedicated web browser of the image AP 30.

The browser control unit 32 generates various screens. The browser control unit 32 displays the generated various screens on the display 24A. In addition, the browser control unit 32 receives various operation instructions, which are input from the input device 25A by the user U, through various screens. The browser control unit 32 transmits various requests in accordance with the operation instructions to the image management server 12.

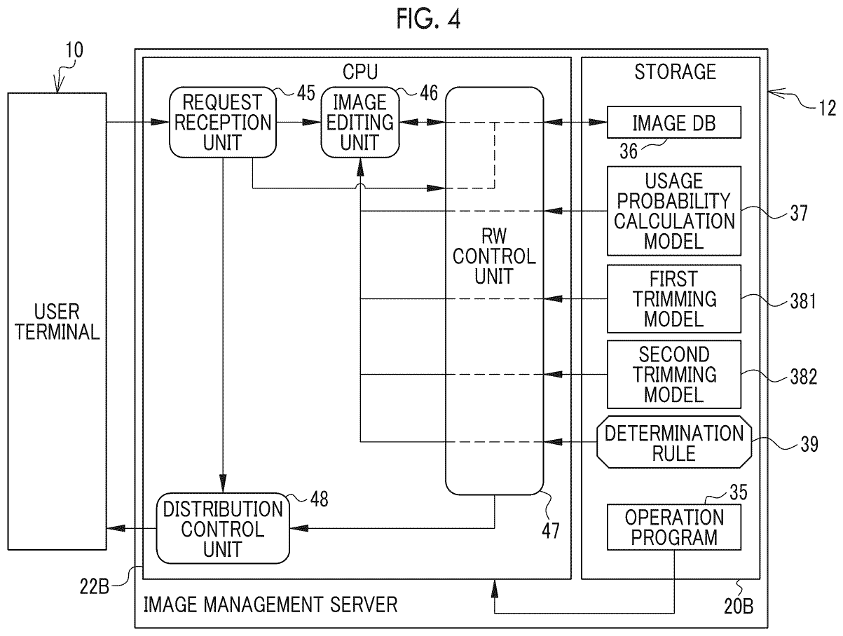

As shown in FIG. 4 as an example, an operation program 35 is stored in the storage 20B of the image management server 12. The operation program 35 is an AP for causing the computer constituting the image management server 12 to function as an “image processing device” according to the technology of the present disclosure. That is, the operation program 35 is an example of an “operation program of an image processing device” according to the technology of the present disclosure.

The storage 20B also stores an image database (hereinafter, referred to as a database (DB)) 36, a usage probability calculation model 37, a first trimming model 381, a second trimming model 382, a determination rule 39, and the like. In addition, although not shown in the drawing, the storage 20B stores a user identification data (ID) for uniquely identifying the user U, a password set by the user U, and a terminal ID for uniquely identifying the user terminal 10, as account information of the user U.

In a case in which the operation program 35 is activated, the CPU 22B of the image management server 12 functions as a request reception unit 45, an image editing unit 46, a read write (hereinafter, referred to as RW) control unit 47, and a distribution control unit 48 in cooperation with the memory 21 and the like.

The request reception unit 45 receives various requests from the user terminal 10. The request reception unit 45 outputs various requests to the image editing unit 46 and/or the RW control unit 47 and the distribution control unit 48.

The image editing unit 46 performs various types of image editing on the image 52. The image editing unit 46 outputs the image 52 on which the image editing has been performed, to the RW control unit 47.

The RW control unit 47 controls the storage of various types of data in the storage 20B and the read-out of various types of data from the storage 20B. In particular, the RW control unit 47 controls the storage of the image 52 in the image DB 36 and the read-out of the image 52 from the image DB 36. In addition, the RW control unit 47 reads out the usage probability calculation model 37, the first trimming model 381, the second trimming model 382, and the determination rule 39 from the storage 20B, and outputs the read-out usage probability calculation model 37, the read-out first trimming model 381, the read-out second trimming model 382, and the read-out determination rule 39 to the image editing unit 46.

The distribution control unit 48 controls the distribution of various types of data to the user terminal 10.

As shown in FIG. 5 as an example, the image DB 36 is provided with a storage area 50 for each user U. The user ID and attribute information 51 are registered in the storage area 50. The attribute information 51 is information indicating an attribute of the user U literally, and includes a gender, an age, a family structure, and the like. The attribute information 51 is acquired, for example, by causing the user U to answer a questionnaire in a case in which the user U installs the image AP 30 in the user terminal 10. Alternatively, the attribute information 51 can be acquired by inferring from the faces of the user U and the family of the user U shown in the image 52. It should be noted that the birthplace, current address, hobby, and the like of the user U may be included in the attribute information 51.

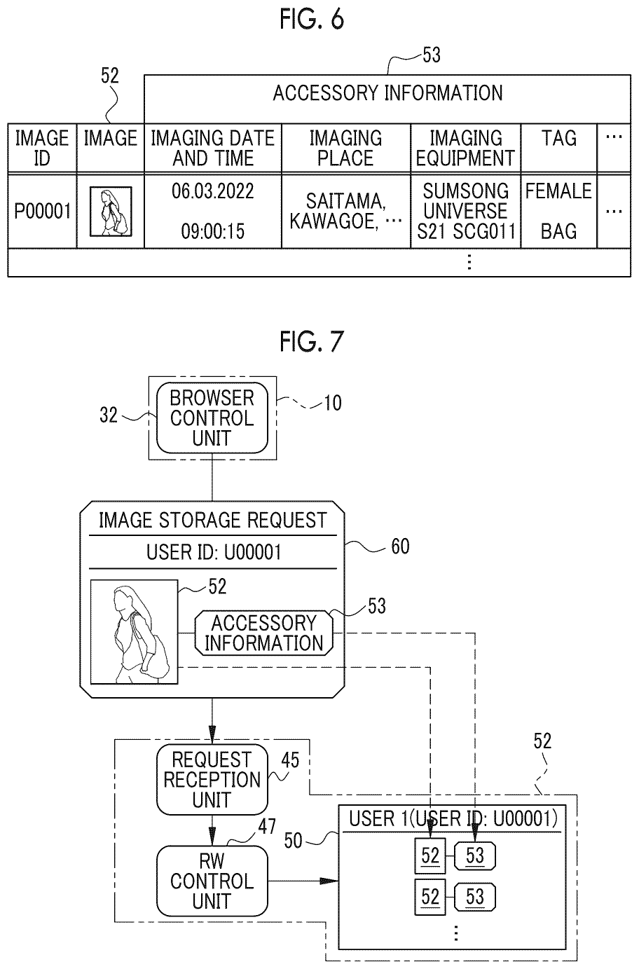

In addition, the storage area 50 stores the image 52 and accessory information 53 of the image 52. As shown in FIG. 6 as an example, the image 52 and the accessory information 53 are associated with each other by an image ID. The accessory information 53 includes a plurality of items such as an imaging date and time, an imaging place, imaging equipment, and a tag. A date and time when the image 52 is captured using the camera function of the user terminal 10 is registered as the imaging date and time. An address and/or a landmark name derived from latitude and longitude information of a place in which the image 52 is captured, which is obtained using a global positioning system (GPS) function of the user terminal 10, is registered as the imaging place. A manufacturer, a name, and a model number of the user terminal 10 that has captured the image 52 are registered in the imaging equipment. The tag is a word that briefly represents a subject shown in the image 52. The tag includes a tag manually input by the user U or a tag derived using a machine learning model for subject discrimination. It should be noted that, although not shown, the accessory information 53 also includes items such as an exposure value, an international organization for standardization (ISO) sensitivity, a shutter speed, a focal length, and the presence or absence of a flash.

As shown in FIG. 7 as an example, the browser control unit 32 transmits an image storage request 60 to the image management server 12 at an appropriate timing such as a case in which the image AP 30 is activated. The image storage request 60 includes the user ID, the image 52, and the accessory information 53. The request reception unit 45 receives the image storage request 60, and outputs the image storage request 60 to the RW control unit 47. The RW control unit 47 stores the image 52 and the accessory information 53 in the image storage request 60 in the storage area 50 of the image DB 36 corresponding to the user ID.

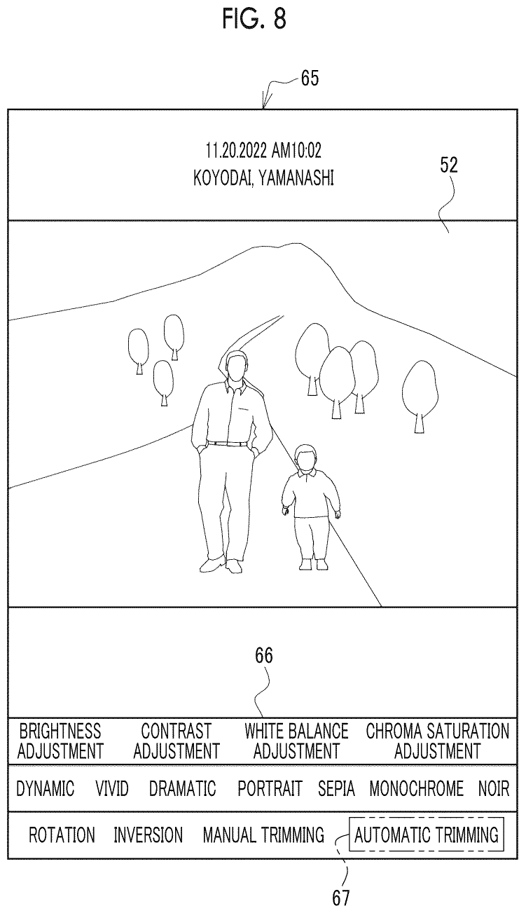

As shown in FIG. 8 as an example, the browser control unit 32 displays an image editing screen 65 on the display 24A in response to the instruction from the user U. The image 52 to be edited is displayed on the image editing screen 65. An image editing instruction button group 66 is disposed at a lower part of the image editing screen 65. The image editing instruction button group 66 includes various image quality adjustment buttons, such as brightness adjustment and chroma saturation adjustment, and various effect buttons, such as dynamic, sepia, and monochrome. In addition, the image editing instruction button group 66 includes various display change buttons, such as rotation, manual trimming, and automatic trimming. The automatic trimming is trimming in which a trimming frame is automatically designated, unlike the manual trimming in which the user U manually designates the trimming frame.

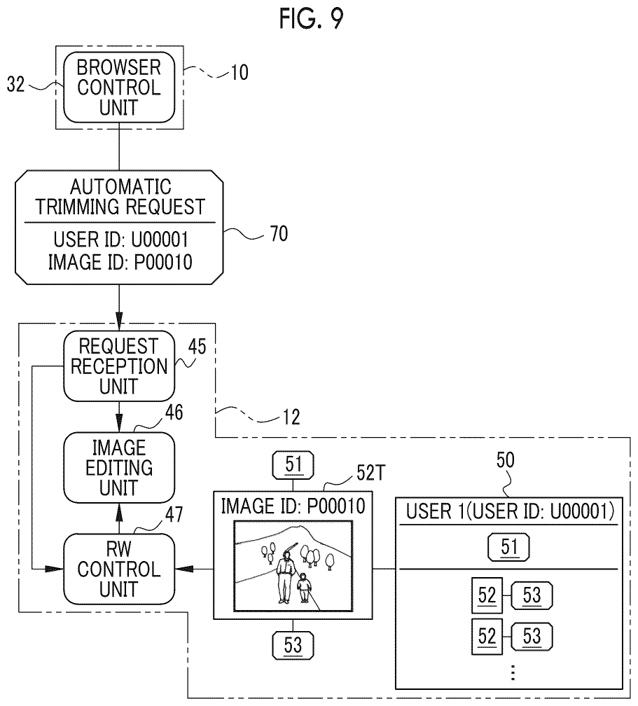

In a case in which an automatic trimming button 67 is selected on the image editing screen 65, as shown in FIG. 9 as an example, the browser control unit 32 transmits an automatic trimming request 70 to the image management server 12. The automatic trimming request 70 includes the user ID and the image ID of the image 52 that is displayed on the image editing screen 65 in a case in which the automatic trimming button 67 is selected and that is a target of the automatic trimming (hereinafter, referred to as a trimming target image 52T). The request reception unit 45 receives the automatic trimming request 70, and outputs the automatic trimming request 70 to the image editing unit 46 and the RW control unit 47.

The RW control unit 47 searches for the image 52 corresponding to the image ID of the automatic trimming request 70, that is, the trimming target image 52T among the images 52 stored in the storage area 50 corresponding to the user ID of the automatic trimming request 70. The RW control unit 47 outputs the searched trimming target image 52T, the accessory information 53 thereof, and the attribute information 51 to the image editing unit 46.

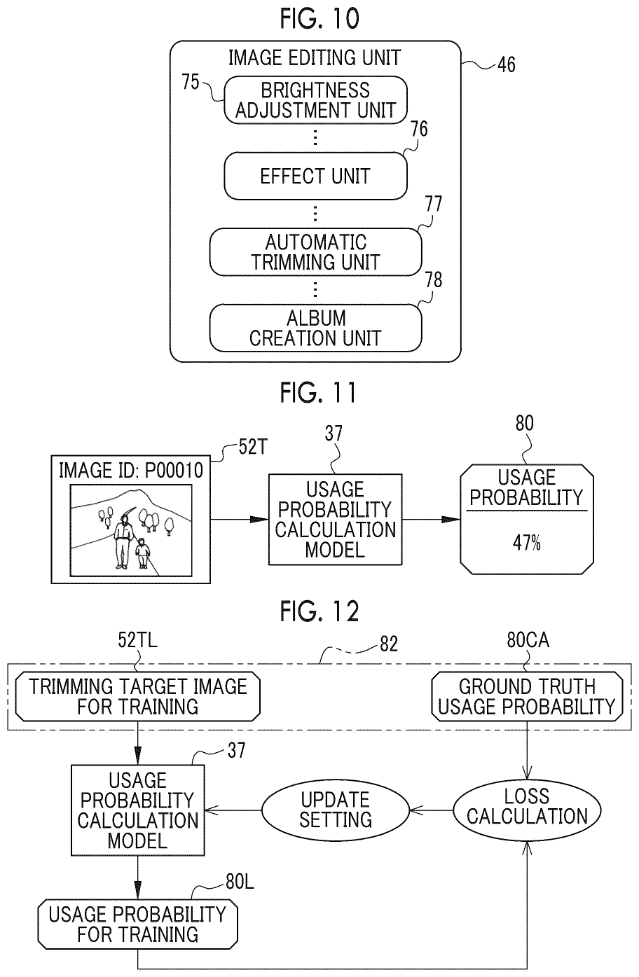

As shown in FIG. 10 as an example, the image editing unit 46 includes various image quality adjustment units such as a brightness adjustment unit 75 that performs processing corresponding to various image quality adjustment buttons, and various display change units such as an effect unit 76 that performs processing corresponding to various effect buttons and an automatic trimming unit 77 that performs processing corresponding to various display change buttons. Further, the image editing unit 46 also includes an album creation unit 78 that creates a photo album. In a case in which the automatic trimming button 67 is selected on the image editing screen 65, the automatic trimming request 70 is received by the request reception unit 45, and the automatic trimming request 70 is input from the request reception unit 45, the automatic trimming unit 77 performs processing described below.

As shown in FIG. 11 as an example, the automatic trimming unit 77 inputs the trimming target image 52T to the usage probability calculation model 37. The usage probability calculation model 37 outputs a probability (hereinafter, referred to as a usage probability) 80 that the trimming target image 52T is used in the photo album, in accordance with the input of the trimming target image 52T. The usage probability 80 is a numerical value between 0% and 100%. The usage probability calculation model 37 is configured by, for example, a machine learning model such as a convolutional neural network. The usage probability is an example of an “evaluation value” according to the technology of the present disclosure. In addition, the usage probability calculation model 37 is an example of a “machine learning model that outputs the evaluation value in response to input of the image” according to the technology of the present disclosure.

As shown in FIG. 12 as an example, the usage probability calculation model 37 is trained by using training data (also referred to as supervised data or learning data) 82. The training data 82 is a set of a trimming target image for training 52TL and a ground truth usage probability 80CA. A plurality of the training data 82 are prepared. The ground truth usage probability 80CA is a usage probability of the trimming target image for training 52TL. The ground truth usage probability 80CA is a result of the selection by an unspecified number of users U as to whether or not to use the trimming target image for training 52TL in the photo album. For example, in a case in which there are 80 users U who have selected to use the trimming target image for training 52TL in the photo album among 100 users U, the ground truth usage probability 80CA is 80%. The ground truth usage probability 80CA is an example of an “evaluation value given by the user for the image” according to the technology of the present disclosure.

In a training phase, the trimming target image for training 52TL is input to the usage probability calculation model 37. As a result, a usage probability for training 80L is output from the usage probability calculation model 37. Then, the usage probability for training 80L and the ground truth usage probability 80CA are compared with each other, and a loss calculation of the usage probability calculation model 37 using a loss function is performed based on a comparison result. Next, update setting of coefficients of the usage probability calculation model 37 is performed in accordance with the result of the loss calculation, and the usage probability calculation model 37 is updated in accordance with the update setting.

In the training phase, the series of processing of inputting the trimming target image for training 52TL to the usage probability calculation model 37, outputting the usage probability for training 80L from the usage probability calculation model 37, performing the loss calculation, performing the update setting, and updating the usage probability calculation model 37 is repeatedly performed while exchanging the training data 82. In a case in which the calculation accuracy of the usage probability for training 80L with respect to the ground truth usage probability 80CA reaches a preset level, the repetition of the series of processing ends, and the usage probability calculation model 37 in this case is stored in the storage 20B and used in the automatic trimming unit 77. It should be noted that, regardless of the calculation accuracy of the usage probability for training 80L with respect to the ground truth usage probability 80CA, the training may end in a case in which the series of processing is repeated a predetermined number of times.

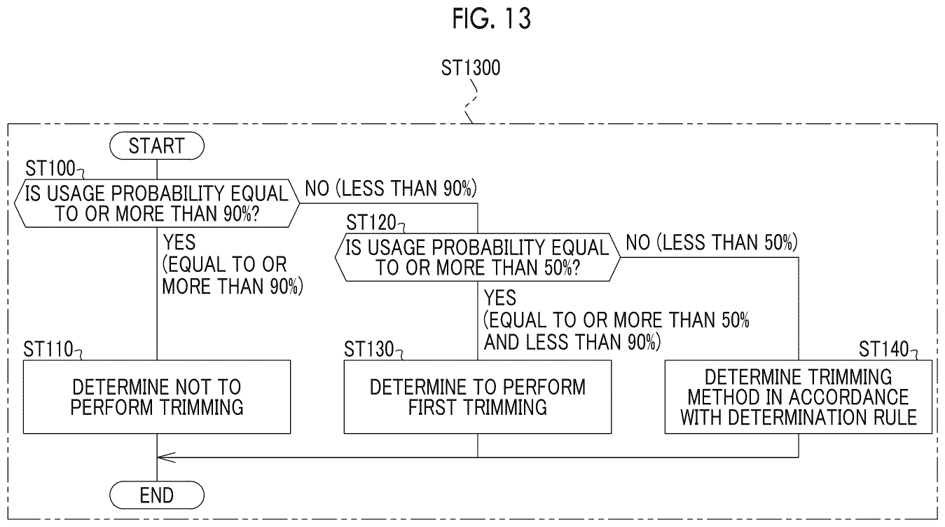

As shown in the flowchart of FIG. 13 as an example, the automatic trimming unit 77 determines the trimming method of the trimming target image 52T based on the usage probability 80. Specifically, in a case in which the usage probability 80 is equal to or more than 90% (YES in step ST100), the automatic trimming unit 77 determines not to trim the trimming target image 52T (step ST110). In this way, the determination on the trimming method also includes determining not to perform the trimming.

In a case in which the usage probability 80 is equal to or more than 50% and less than 90% (NO in step ST100, YES in step ST120), the automatic trimming unit 77 determines to perform the first trimming on the trimming target image 52T by the first trimming model 381 (step ST130). In a case in which the usage probability 80 is less than 50% (NO in step ST120), the automatic trimming unit 77 determines the trimming method according to the determination rule 39 (step ST140). Here, 90% is an example of a “first threshold” according to the technology of the present disclosure. In addition, 50% is an example of a “second threshold” according to the technology of the present disclosure.

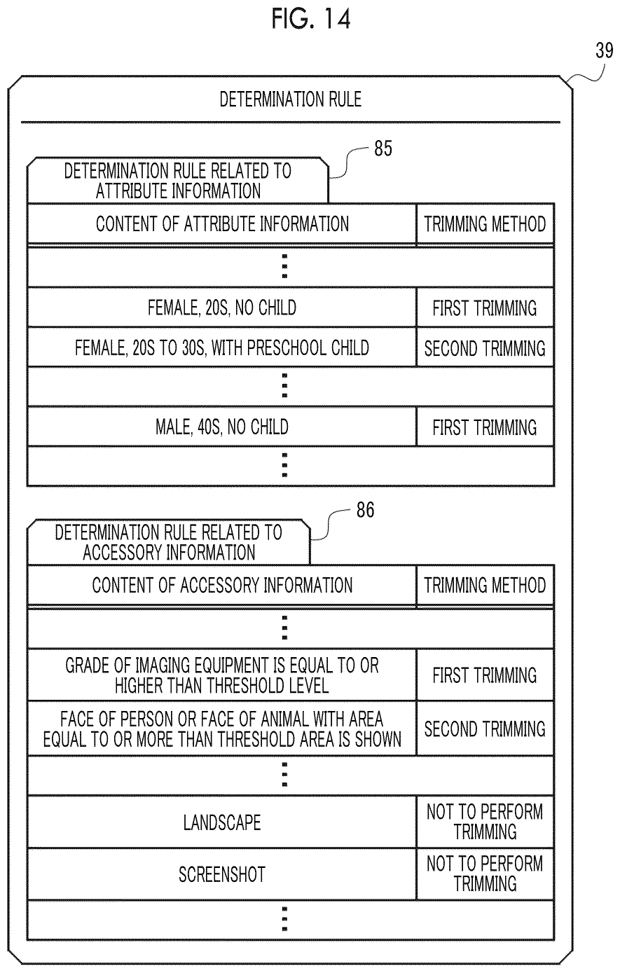

As shown in FIG. 14 as an example, the determination rule 39 includes a determination rule 85 related to the attribute information 51 and a determination rule 86 related to the accessory information 53. The determination rule 85 related to the attribute information 51 and the determination rule 86 related to the accessory information 53 are set based on a result of the marketing performed in advance. The result of the marketing performed in advance means that the user U having specific attribute information 51 tends to prefer the first trimming or the image 52 having specific accessory information 53 tends to be subjected to the second trimming.

In the determination rule 85 related to the attribute information 51, a content of the attribute information 51 and the trimming method corresponding to the content of the attribute information 51 are registered. For example, in a case in which the content of the attribute information 51 is “woman, 20s, no child”, “first trimming” is registered as the trimming method. In addition, in a case in which the content of the attribute information 51 is “female, 20s to 30s, with preschool child”, “second trimming” is registered as the trimming method.

In the determination rule 86 related to the accessory information 53, a content of the accessory information 53 and the trimming method corresponding to the content of the accessory information 53 are registered. For example, in a case in which the content of the accessory information 53 is “a grade of the imaging equipment is equal to or higher than a threshold level”, “first trimming” is registered as the trimming method. In addition, in a case in which the content of the accessory information 53 is “a face of a person or a face of an animal with an area equal to or larger than a threshold area is shown”, “second trimming” is registered as the trimming method. Further, in a case in which the content of the accessory information 53 is “landscape” and “screenshot”, “not to perform trimming” is registered as the trimming method. Whether or not the grade of the imaging equipment is equal to or higher than the threshold level can be determined from information on the imaging equipment in the accessory information 53. In addition, whether or not the face of the person or the face of the animal with the area equal to or larger than the threshold area is captured can be determined from a result of performing processing of recognizing the face of the person or the face of the animal on the trimming target image 52T.

It should be noted that, in a case in which the trimming methods are different between the determination rule 85 related to the attribute information 51 and the determination rule 86 related to the accessory information 53, the trimming method of the determination rule 85 related to the attribute information 51 is prioritized. For example, in a case in which the attribute information 51 is “male, 40s, no child” and the accessory information 53 is “landscape”, the determination rule 85 related to the attribute information 51 of “first trimming” is adopted instead of the determination rule 86 of “not to perform trimming” related to the accessory information 53. Alternatively, in a case in which there are four or more corresponding trimming methods, the trimming method with the largest number of trimming methods may be adopted.

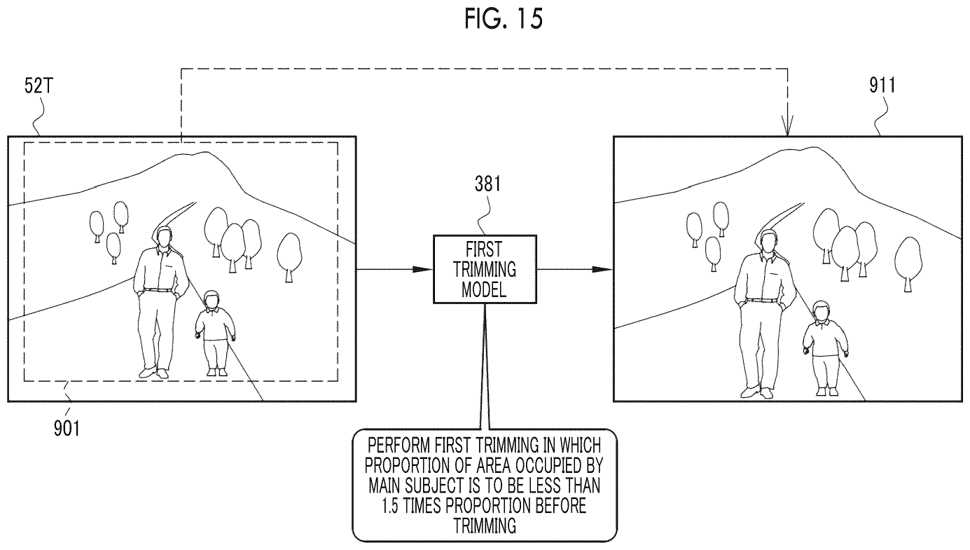

As shown in FIG. 15 as an example, the first trimming model 381 performs the first trimming on the trimming target image 52T. The first trimming is trimming in which a proportion of an area occupied by a main subject is to be less than 1.5 times a proportion before the trimming. For this reason, it can be said that the first trimming is trimming that emphasizes the composition more than the main subject. The first trimming model 381 sets a first trimming frame 901 in which the proportion of the area occupied by the main subject is to be less than 1.5 times the proportion before the trimming, on the trimming target image 52T. The first trimming model 381 trims the trimming target image 52T in the set first trimming frame 901, and outputs a first trimmed image 911. Here, 1.5 times is an example of a “third threshold multiple” according to the technology of the present disclosure.

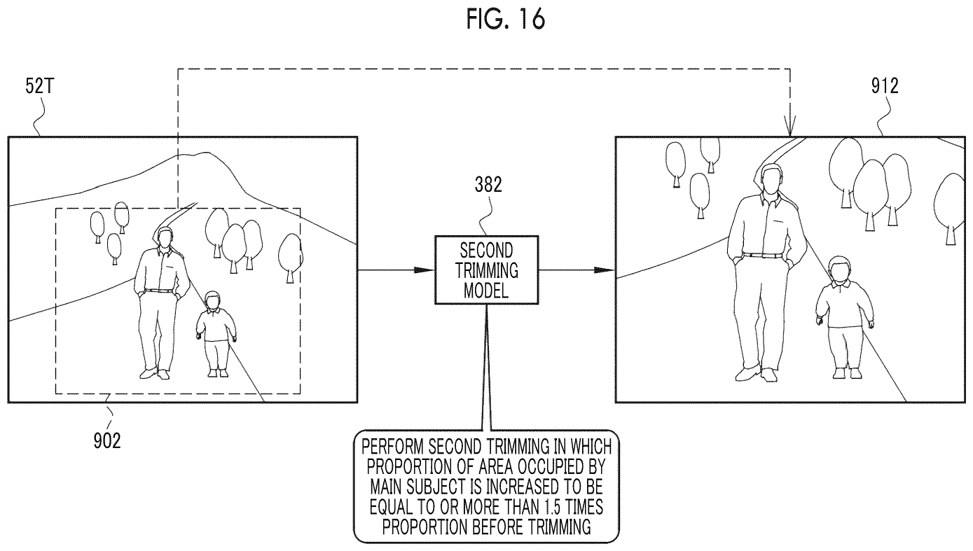

The main subject is the face of the person, the face of the animal, a head of a vehicle, a building, or the like recognized by image recognition processing. In a case in which the face of the person, the face of the animal, the head of the vehicle, the building, or the like is not shown in the trimming target image 52T such as a landscape image, a subject shown in a central region of the trimming target image 52T is set as the main subject. In FIG. 15, since the face of the person is shown in the trimming target image 52T, the main subject is the face of the person (the same applies to FIG. 16).

As shown in FIG. 16 as an example, the second trimming model 382 performs the second trimming on the trimming target image 52T. The second trimming is trimming in which the proportion of the area occupied by the main subject is increased to be equal to or more than 1.5 times the proportion before the trimming. Therefore, it can be said that the second trimming is trimming that emphasizes the main subject more than the composition as compared with the first trimming. The second trimming model 382 sets a second trimming frame 902 in which the proportion of the area occupied by the main subject is increased to be equal to or more than 1.5 times the proportion before the trimming, on the trimming target image 52T. The second trimming model 382 trims the trimming target image 52T in the set second trimming frame 902, and outputs a second trimmed image 912.

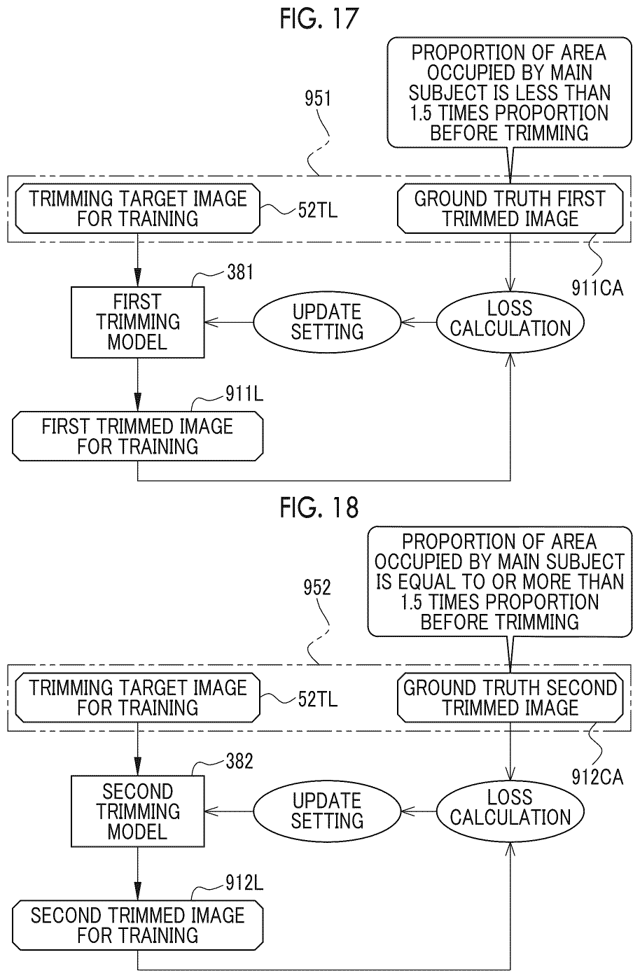

As shown in FIG. 17 as an example, the first trimming model 381 is trained using first training data 951. The first training data 951 is a set of the trimming target image for training 52TL and a ground truth first trimmed image 911CA. A plurality of the first training data 951 are prepared. The ground truth first trimmed image 911CA is an image generated by performing the trimming, in which the user U emphasizes the composition more than the main subject, on the trimming target image for training 52TL. The ground truth first trimmed image 911CA is an image in which the proportion of the area occupied by the main subject is less than 1.5 times the proportion of the area before the trimming.

In the training phase, the trimming target image for training 52TL is input to the first trimming model 381. As a result, a first trimmed image for training 911L is output from the first trimming model 381. Then, the first trimmed image for training 911L and the ground truth first trimmed image 911CA are compared with each other, and the loss calculation of the first trimming model 381 using the loss function is performed based on a comparison result. Next, update setting of coefficients of the first trimming model 381 is performed in accordance with the result of the loss calculation, and the first trimming model 381 is updated in accordance with the update setting.

In the training phase, the series of processing of inputting the trimming target image for training 52TL to the first trimming model 381, outputting the first trimmed image for training 911L from the first trimming model 381, performing the loss calculation, performing the update setting, and updating the first trimming model 381 is repeatedly performed while the first training data 951 is exchanged. In a case in which the prediction accuracy of the first trimmed image for training 911L with respect to the ground truth first trimmed image 911CA reaches a preset level, the repetition of the series of processing ends, and the first trimming model 381 in this case is stored in the storage 20B and used in the automatic trimming unit 77. It should be noted that, regardless of the prediction accuracy of the first trimmed image for training 911L with respect to the ground truth first trimmed image 911CA, the training may end in a case in which the series of processing is repeatedly performed a predetermined number of times.

As shown in FIG. 18 as an example, the second trimming model 382 is trained using second training data 952. The second training data 952 is a set of the trimming target image for training 52TL and a ground truth second trimmed image 912CA. A plurality of the second training data 952 are prepared. The ground truth second trimmed image 912CA is an image generated by performing the trimming in which the user U emphasizes the main subject more than the composition, on the trimming target image for training 52TL. The ground truth second trimmed image 912CA is an image in which the proportion of the area occupied by the main subject is equal to or more than 1.5 times the proportion before the trimming.

In the training phase, the trimming target image for training 52TL is input to the second trimming model 382. As a result, a second trimmed image for training 912L is output from the second trimming model 382. Then, the second trimmed image for training 912L is compared with the ground truth second trimmed image 912CA, and the loss calculation of the second trimming model 382 using the loss function is performed based on a comparison result. Next, update setting of coefficients of the second trimming model 382 is performed in accordance with the result of the loss calculation, and the second trimming model 382 is updated in accordance with the update setting.

In the training phase, the series of processing of inputting the trimming target image for training 52TL to the second trimming model 382, outputting the second trimmed image for training 912L from the second trimming model 382, performing the loss calculation, performing the update setting, and updating the second trimming model 382 is repeatedly performed while the second training data 952 is exchanged. In a case in which the prediction accuracy of the second trimmed image for training 912L with respect to the ground truth second trimmed image 912CA reaches a preset level, the repetition of the series of processing ends, and the second trimming model 382 in this case is stored in the storage 20B and used in the automatic trimming unit 77. It should be noted that, regardless of the prediction accuracy of the second trimmed image for training 912L with respect to the ground truth second trimmed image 912CA, the training may end in a case in which the series of processing is repeatedly performed a predetermined number of times.

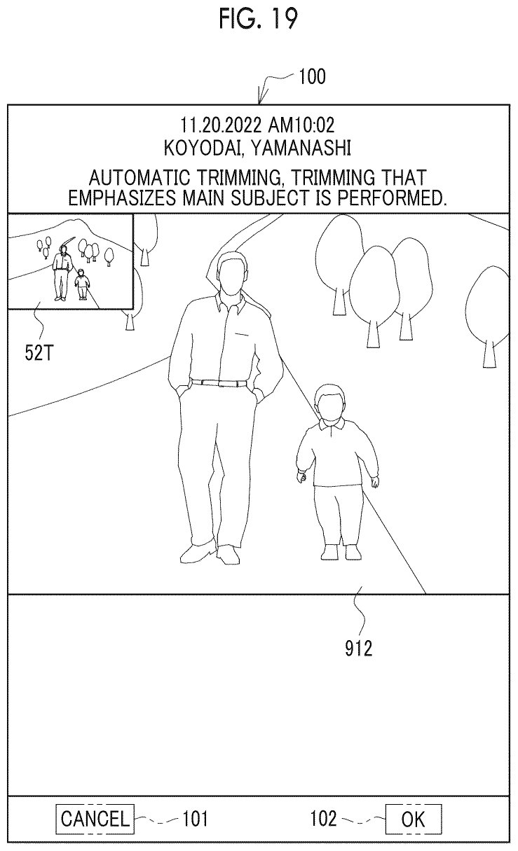

As shown in FIG. 19 as an example, the browser control unit 32 of the user terminal 10 displays an automatic trimming result display screen 100 on the display 24A. On the automatic trimming result display screen 100, the trimming target image 52T is displayed in a case in which the trimming is not performed, the first trimmed image 911 is displayed in a case in which the first trimming is performed, and the second trimmed image 912 is displayed in a case in which the second trimming is performed. FIG. 19 shows an example in which the second trimming is performed, and the second trimmed image 912 is displayed. In a case in which the first trimming or the second trimming is performed, the trimming target image 52T is displayed in a nested manner on the upper left of the first trimmed image 911 or the second trimmed image 912. In a case in which the first trimming or the second trimming is performed, explanatory text representing the content of the first trimming or the second trimming (FIG. 19 shows an example of explanatory text “trimming that emphasizes the main subject is performed” representing the content of the second trimming) is displayed on an upper part of the first trimmed image 911 or the second trimmed image 912. It should be noted that, in a case in which the first trimming is performed, for example, explanatory text such as “trimming that emphasizes composition is performed” is displayed.

A cancel button 101 and an OK button 102 are provided at a lower part of the automatic trimming result display screen 100. In a case in which a result of the automatic trimming is not satisfactory, the user U selects the cancel button 101. In a case in which the cancel button 101 is selected, the first trimmed image 911 or the second trimmed image 912 is discarded.

On the other hand, in a case in which the result of the automatic trimming is appropriate, the user U selects the OK button 102. In a case in which the OK button 102 is selected, the image storage request 60 of the first trimmed image 911 or the second trimmed image 912 is transmitted from the browser control unit 32. As a result, the first trimmed image 911 or the second trimmed image 912 is stored in the image DB 36 in association with an original trimming target image 52T. Even in a case in which any one of the cancel button 101 or the OK button 102 is selected, the browser control unit 32 transitions the screen from the automatic trimming result display screen 100 to the image editing screen 65. It should be noted that, in a case in which the trimming is not performed, the browser control unit 32 does nothing even in a case in which any one of the cancel button 101 or the OK button 102 is selected.

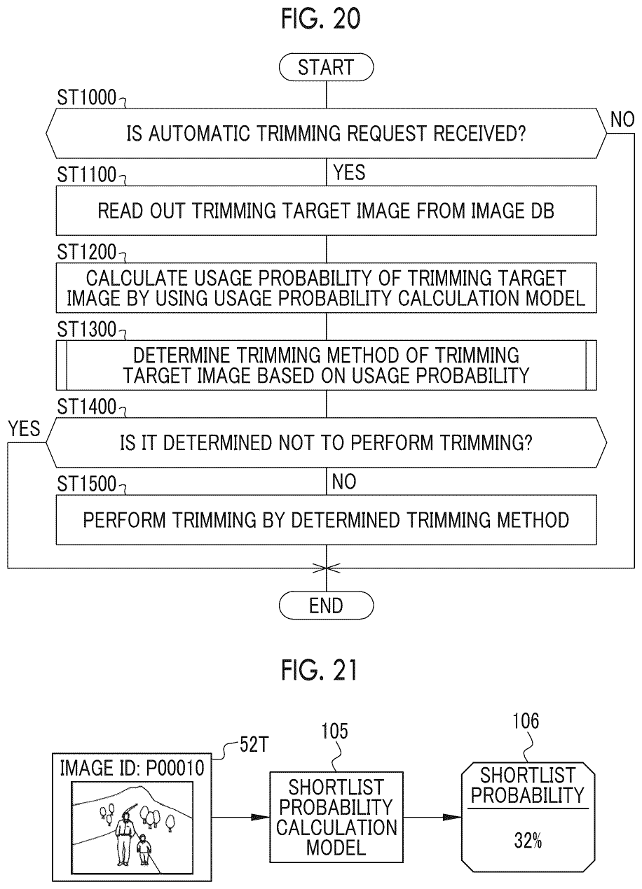

Next, an operation of the configuration described above will be described with reference to a flowchart shown in FIG. 20 as an example. As shown in FIG. 3, the CPU 22A of the user terminal 10 functions as the browser control unit 32 by activation of the image AP 30. In addition, as shown in FIG. 4, the CPU 22B of the image management server 12 functions as the request reception unit 45, the image editing unit 46, the RW control unit 47, and the distribution control unit 48 by activation of the operation program 35.

The user U captures the image 52 by using the camera function of the user terminal 10. As shown in FIG. 7, under the control of the browser control unit 32, the image storage request 60 including the image 52 and the accessory information 53 is transmitted to the image management server 12.

In the image management server 12, the image storage request 60 is received by the request reception unit 45. The image storage request 60 is output from the request reception unit 45 to the RW control unit 47. The image 52 and the accessory information 53 are stored in the image DB 36 under the control of the RW control unit 47.

As shown in FIG. 8, the user U selects the automatic trimming button 67 on the image editing screen 65 in order to perform the automatic trimming. As a result, as shown in FIG. 9, the automatic trimming request 70 is generated by the browser control unit 32, and the automatic trimming request 70 is transmitted to the image management server 12.

In the image management server 12, the automatic trimming request 70 is received by the request reception unit 45 (YES in step ST1000). The automatic trimming request 70 is output from the request reception unit 45 to the image editing unit 46 and the RW control unit 47. Then, the image 52, that is, the trimming target image 52T in accordance with the automatic trimming request 70 is read out from the image DB 36 under the control of the RW control unit 47 (step ST1100). In addition, the attribute information 51 of the user U, who owns the trimming target image 52T and the accessory information 53 of the trimming target image 52T, are also read out. The image 52 is output from the RW control unit 47 to the image editing unit 46, together with the attribute information 51 and the accessory information 53.

In the automatic trimming unit 77 of the image editing unit 46, first, as shown in FIG. 11, the trimming target image 52T is input to the usage probability calculation model 37, and the usage probability 80 of the trimming target image 52T is output from the usage probability calculation model 37 (step ST1200).

Next, as shown in FIG. 13, the trimming method of the trimming target image 52T is determined based on the usage probability 80 (step ST1300). Specifically, in a case in which the usage probability 80 is equal to or more than 90%, it is determined not to trim the trimming target image 52T. In a case in which the usage probability 80 is equal to or more than 50% and less than 90%, it is determined to perform the first trimming on the trimming target image 52T by the first trimming model 381. In a case in which the usage probability 80 is less than 50%, the trimming method is determined in accordance with the determination rule 39.

In a case in which it is determined in step ST1300 not to perform the trimming (YES in step ST1400), the automatic trimming result display screen 100 on which the trimming target image 52T itself is displayed is displayed on the display 24A under the control of the browser control unit 32 in the user terminal 10.

On the other hand, in a case in which it is determined to perform any one of the first trimming or the second trimming in step ST1300 (NO in step ST1400), the trimming is performed on the trimming target image 52T by the determined trimming method (step ST1500). Specifically, in a case in which it is determined to perform the first trimming, as shown in FIG. 15, the trimming target image 52T is input to the first trimming model 381, and the first trimmed image 911 is output from the first trimming model 381. In a case in which it is determined to perform the second trimming, as shown in FIG. 16, the trimming target image 52T is input to the second trimming model 382, and the second trimmed image 912 is output from the second trimming model 382. The first trimmed image 911 or the second trimmed image 912 is distributed to the user terminal 10, which is a request source of the automatic trimming request 70, under the control of the distribution control unit 48. In the user terminal 10, the automatic trimming result display screen 100 on which the first trimmed image 911 or the second trimmed image 912 is displayed is displayed on the display 24A under the control of the browser control unit 32.

As described above, the automatic trimming unit 77 obtains the usage probability 80 of the trimming target image 52T, and determines the trimming method of the trimming target image 52T based on the usage probability 80. Therefore, the trimming target image 52T can be trimmed by the trimming method in accordance with the usage probability 80. It is possible to easily determine the trimming method of the trimming target image 52T by using a relatively simple indicator of the usage probability 80.

With the usage probability 80, it is possible to estimate an imaging skill of the user U who owns the trimming target image 52T or how much the user U is conscious of the photo album. Therefore, in a case in which the trimming method of the trimming target image 52T is determined based on the usage probability 80, it is possible to suggest a trimming method that matches the preference of the user U, such as the imaging skill and the consciousness of the photo album.

As shown in FIG. 11, the automatic trimming unit 77 uses the usage probability calculation model 37 that outputs the usage probability 80 in response to the input of the trimming target image 52T. Therefore, it is possible to easily calculate the usage probability 80.

As shown in FIG. 12, the usage probability calculation model 37 has been trained using a plurality of training data 82 composed of a set of the trimming target image for training 52TL and the ground truth usage probability 80CA that is the usage probability 80 given by the user U with respect to the trimming target image for training 52TL. Therefore, it is possible to calculate the usage probability 80 having relatively high reliability.

As shown in FIG. 9, the automatic trimming unit 77 acquires the attribute information 51 of the user U who owns the trimming target image 52T, and the accessory information 53 of the trimming target image 52T. As shown in FIGS. 13 and 14, the automatic trimming unit 77 determines the trimming method of the trimming target image 52T based on the attribute information 51 and the accessory information 53, in addition to the usage probability 80. Therefore, it is possible to suggest a trimming method that matches the attribute information 51 of the user U and the accessory information 53 of the trimming target image 52T.

As shown in FIG. 13, in a case in which the usage probability 80 is equal to or more than 90%, the automatic trimming unit 77 determines not to trim the trimming target image 52T. In a case in which the usage probability 80 is equal to or more than 50% and less than 90%, the automatic trimming unit 77 determines to perform the first trimming in which the proportion of the area occupied by the main subject is to be less than 1.5 times the proportion before the trimming. In a case in which the usage probability 80 is less than 50%, the automatic trimming unit 77 determines the trimming method based on the attribute information 51 and the accessory information 53.

In a case in which the usage probability 80 is equal to or more than 90%, that is, in a case in which the usage probability 80 is relatively high, the trimming target image 52T may be used as it is without being trimmed, as a sufficiently good image. In a case in which the usage probability 80 is equal to or more than 50% and less than 90%, that is, in a case in which the usage probability 80 is moderate, it is preferable to trim off an unnecessary portion in which the usage probability 80 is lowered while making the original composition of the trimming target image 52T as much as possible. In a case in which the usage probability 80 is less than 50%, that is, in a case in which the usage probability 80 is relatively low, it is considered that the original composition or the like of the trimming target image 52T is not very good, and thus trimming corresponding to the characteristics of each trimming target image 52T is required. Therefore, in a case in which the trimming method is determined based on the magnitude of the usage probability 80 as described above, trimming can be performed by an appropriate trimming method in accordance with the usage probability 80, and a satisfaction level of the user U with respect to the automatic trimming processing can be increased.

As shown in FIG. 14, in a case in which the usage probability 80 is less than 50%, the automatic trimming unit 77 determines to perform any one of the first trimming or the second trimming in accordance with at least one of the attribute information 51 or the accessory information 53. Therefore, in a case in which the usage probability 80 is relatively low, trimming can be performed by an appropriate trimming method in accordance with at least one of the attribute information 51 or the accessory information 53, and the satisfaction level of the user U with respect to the automatic trimming processing can be increased.

### Modification Example 1

In the above-described example, the usage probability 80 is shown as the evaluation value, but the present disclosure is not limited to this. As shown in FIG. 21 as an example, a shortlist probability calculation model 105 may be used instead of the usage probability calculation model 37, and a probability (hereinafter, referred to as a shortlist probability) 106 that the trimming target image 52T is shortlisted for a photo contest may be calculated as the evaluation value instead of the usage probability 80.

The automatic trimming unit 77 inputs the trimming target image 52T to the shortlist probability calculation model 105. The shortlist probability calculation model 105 outputs the shortlist probability 106 in response to the input of the trimming target image 52T. The shortlist probability 106 is a numerical value between 0% and 100%, similar to the usage probability 80. The shortlist probability calculation model 105 is configured by, for example, a machine learning model such as a convolutional neural network, similarly to the usage probability calculation model 37. The shortlist probability is an example of an “evaluation value” according to the technology of the present disclosure. In addition, the shortlist probability calculation model 105 is an example of a “machine learning model that outputs the evaluation value in response to input of the image” according to the technology of the present disclosure.

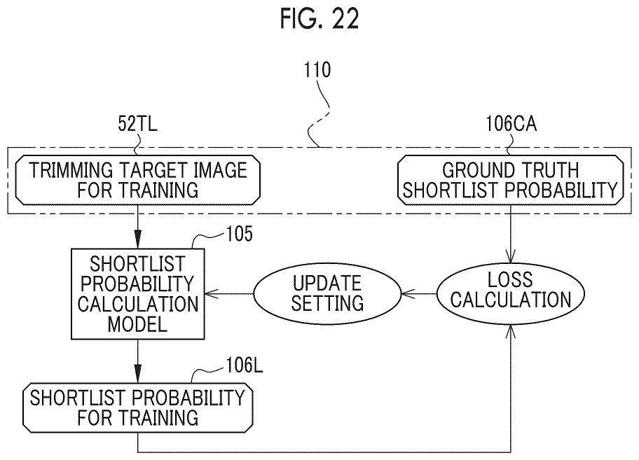

As shown in FIG. 22 as an example, the shortlist probability calculation model 105 is trained using training data 110. The training data 110 is a set of the trimming target image for training 52TL and a ground truth shortlist probability 106CA. A plurality of the training data 110 are prepared. The ground truth shortlist probability 106CA is a shortlist probability of the trimming target image for training 52TL. The ground truth shortlist probability 106CA is a result of the selection by an unspecified number of users U as to whether or not to shortlist the trimming target image for training 52TL for the photo contest. For example, in a case in which there are 20 users U who have selected the trimming target image for training 52TL to be shortlisted for the photo contest among 100 users U, the ground truth shortlist probability 106CA is 20%. The ground truth shortlist probability 106CA is an example of an “evaluation value given by the user for the image” according to the technology of the present disclosure. It should be noted that it is preferable that the user U involved in the generation of the ground truth shortlist probability 106CA includes the user U who can correctly determine whether or not to shortlist the trimming target image for training 52TL for the photo contest. The user U is, for example, a person of which the imaging skill is at a relatively high level or a person who has experience as a judge of a photo contest.

In the training phase, the trimming target image for training 52TL is input to the shortlist probability calculation model 105. As a result, a shortlist probability for training 106L is output from the shortlist probability calculation model 105. Then, the shortlist probability for training 106L and the ground truth shortlist probability 106CA are compared with each other, and the loss calculation of the shortlist probability calculation model 105 using the loss function is performed based on a comparison result. Next, update setting of coefficients of the shortlist probability calculation model 105 is performed in accordance with the result of the loss calculation, and the shortlist probability calculation model 105 is updated in accordance with the update setting.

In the training phase, the series of processing of inputting the trimming target image for training 52TL to the shortlist probability calculation model 105, outputting the shortlist probability for training 106L from the shortlist probability calculation model 105, performing the loss calculation, performing the update setting, and updating the shortlist probability calculation model 105 is repeatedly performed while exchanging the training data 110. In a case in which the calculation accuracy of the shortlist probability for training 106L with respect to the ground truth shortlist probability 106CA reaches a preset level, the repetition of the series of processing ends, and the shortlist probability calculation model 105 in this case is stored in the storage 20B and used in the automatic trimming unit 77. It should be noted that, regardless of the calculation accuracy of the shortlist probability for training 106L with respect to the ground truth shortlist probability 106CA, the training may end in a case in which the series of processing is repeatedly performed a predetermined number of times.

As described above, the evaluation value is not limited to the usage probability 80 and may be the shortlist probability 106. With the shortlist probability 106, it is possible to estimate the imaging skill of the user U who owns the trimming target image 52T or how much the user U is conscious of the photo contest. Therefore, in a case in which the trimming method of the trimming target image 52T is determined based on the shortlist probability 106, it is possible to suggest a trimming method that matches the preference of the user U, such as the imaging skill and the consciousness for the photo contest.

Both the usage probability 80 and the shortlist probability 106 may be calculated, and a representative value such as an average value, a maximum value, and a minimum value thereof may be used as the evaluation value.

### Modification Example 2

In the above-described example, the determination rule 85 related to the attribute information 51 and the determination rule 86 related to the accessory information 53 are shown, but the present disclosure is not limited to this.

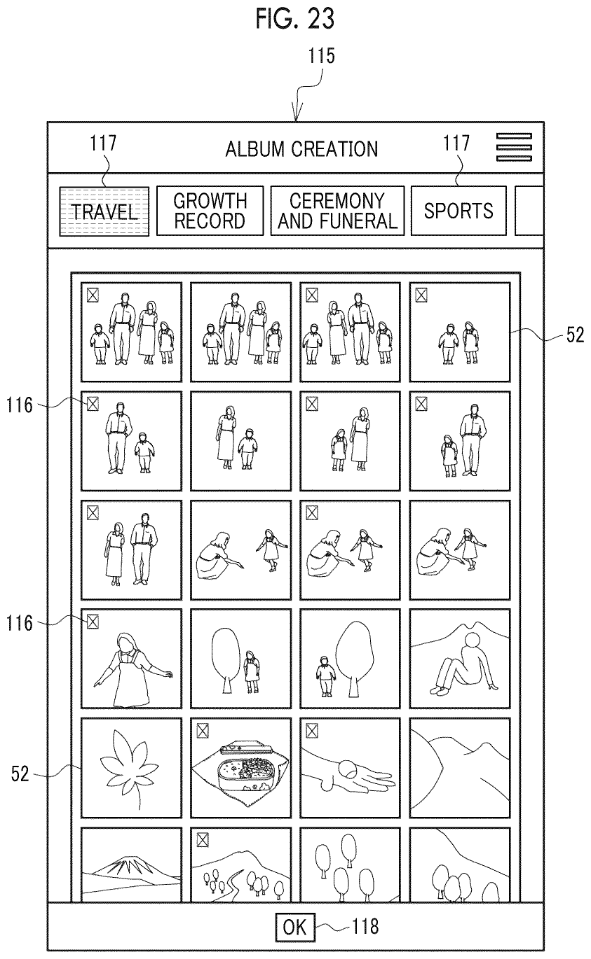

As shown in FIG. 23 as an example, the browser control unit 32 displays an album creation screen 115 on the display 24A in response to the instruction from the user U. In the album creation screen 115, the images 52 are arranged vertically and horizontally and displayed in a list. The user U can select the image 52 to be used in the photo album from among the images 52 displayed in a list. A check mark 116 is displayed on the image 52 selected by the user U. In the present example, all the images 52 selected by the user U are the trimming target images 52T.

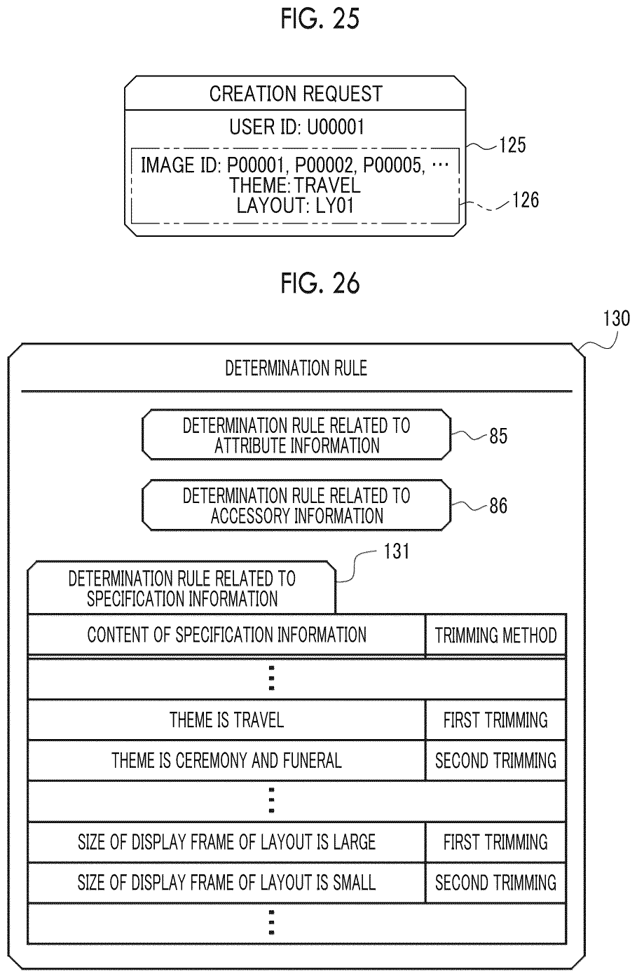

A plurality of theme selection buttons 117 for selecting a theme of the photo album are provided at an upper part of the album creation screen 115. The theme selection buttons 117 include “travel”, “growth record”, “ceremony and funeral”, and “sports”. The user U selects the image 52 to be used in the photo album, selects a desired theme selection button 117, and then selects the OK button 118 disposed at the lower part of the album creation screen 115. As a result, a creation request 125 (see FIG. 25) for the photo album using the selected image 52 in accordance with the theme selected by the theme selection button 117 is issued from the browser control unit 32. FIG. 23 shows a case in which the theme selection button 117 of “travel” is selected.

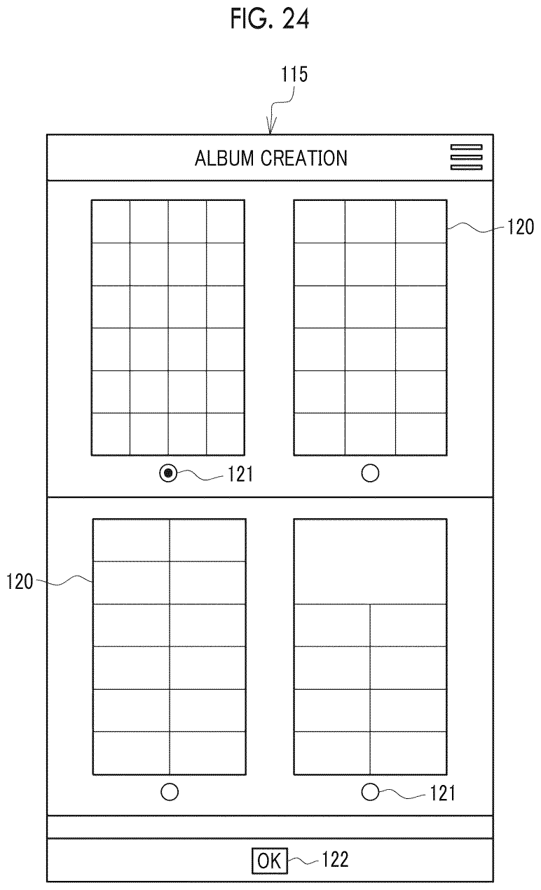

As shown in FIG. 24 as an example, a layout 120 of the photo album can be selected on the album creation screen 115. Specifically, a plurality of layouts 120, which can be selected, are displayed in a list on the album creation screen 115 in response to the instruction of the user U. A radio button 121 for selectively selecting the layout 120 is provided at a lower part of each layout 120. In the layout 120, the size of the display frame for each image 52 ranges from relatively small to relatively large. Further, the layout 120 may include a mixture of display frames having relatively large sizes and display frames having relatively small sizes. The user U selects the radio button 121 of a desired layout 120 and then selects the OK button 122. Accordingly, the layout 120 desired by the user U is selected.

As shown in FIG. 25 as an example, the creation request 125 includes the user ID and specification information 126 of the photo album. In the specification information 126, the image ID of the image 52 selected by the user U on the album creation screen 115 shown in FIG. 23, the theme selected by the user U using the theme selection button 117, and a layout ID of the layout 120 selected by the user U on the album creation screen 115 shown in FIG. 24 are registered.

The creation request 125 is received by the request reception unit 45 of the image management server 12, and is output from the request reception unit 45 to the album creation unit 78 of the image editing unit 46. Then, the photo album in accordance with the creation request 125 is created by the album creation unit 78. The created photo album is stored in the storage 20B under the control of the RW control unit 47. In addition, the created photo album is distributed to the user terminal 10, which is a request source of the creation request 125, under the control of the distribution control unit 48.

As shown in FIG. 26 as an example, a determination rule 130 of the present example includes a determination rule 131 related to the specification information 126, in addition to the determination rule 85 related to the attribute information 51 and the determination rule 86 related to the accessory information 53. The determination rule 131 related to the specification information 126 is also set based on the result of the marketing performed in advance, similarly to the other determination rules 85 and 86. In the determination rule 131 related to the specification information 126, a content of the specification information 126 and the trimming method corresponding to the content of the specification information 126 are registered. For example, in a case in which the theme of the specification information 126 is “travel”, “first trimming” is registered as the trimming method. In addition, in a case in which the size of the display frame of the layout 120 of the specification information 126 is “small”, “second trimming” is registered as the trimming method.

It should be noted that the theme of the photo album includes a “specific person” who creates the photo album with the image 52 in which a specific person registered in advance is shown. Although not shown, in the determination rule 131 related to the specification information 126, the “second trimming” is registered as the trimming method in a case in which the theme is “specific person”.

The size of the display frame of the layout 120 is classified as “small” in a case in which the size is smaller than a preset threshold, and is classified as “large” in a case in which the size is equal to or larger than the threshold. For the layout 120 in which the display frame having a relatively large size and the display frame having a relatively small size are mixed, each display frame is classified as “small” or “large”, and the trimming method is determined for each image 52 assigned to each display frame. It should be noted that, in a case in which the trimming method for the theme and the trimming method for the size of the display frame of the layout 120 are different from each other, the trimming method for the theme is prioritized.

In a case in which the usage probability 80 is less than 50%, the automatic trimming unit 77 determines the trimming method in accordance with the determination rule 130. That is, in a case in which the usage probability 80 is less than 50%, the automatic trimming unit 77 determines the trimming method based on at least one of the attribute information 51, the accessory information 53, or the specification information 126. It should be noted that, instead of or in addition to the usage probability 80, the shortlist probability 106 described in Modification Example 1 may be used.

In this way, in Modification Example 2, the trimming method is determined based on the specification information 126 in addition to the attribute information 51 and the accessory information 53. Therefore, it is possible to suggest a trimming method that matches not only the attribute information 51 of the user U and the accessory information 53 of the trimming target image 52T but also the specification information 126 of the photo album.

### Second Embodiment

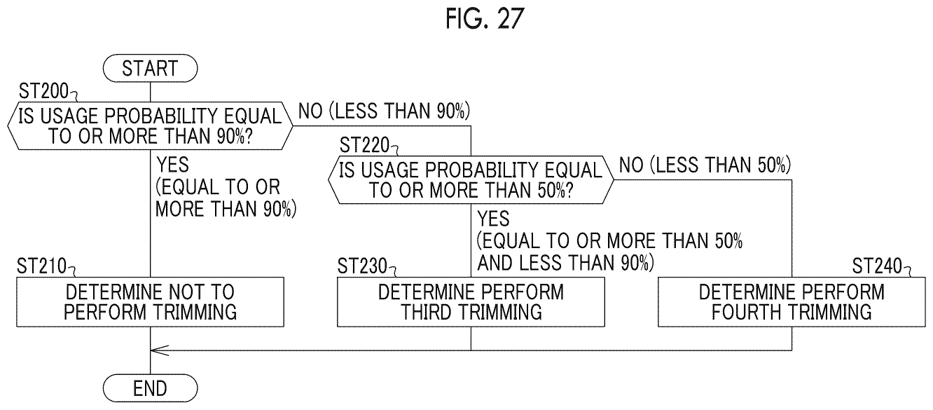

In the first embodiment, the automatic trimming unit 77 determines the trimming method based on at least one of the attribute information 51, the accessory information 53, or the specification information 126 in a case in which the usage probability 80 is less than 50%, but the present disclosure is not limited to this. As an example, the trimming method may be determined as shown in a flowchart of FIG. 27.

In FIG. 27, in a case in which the usage probability 80 is equal to or more than 90% (YES in step ST200), the automatic trimming unit 77 determines not to trim the trimming target image 52T as in the first embodiment (step ST210). Even in a case in which the usage probability 80 is equal to or more than 50% and less than 90% (NO in step ST200, YES in step ST220), the automatic trimming unit 77 determines to perform third trimming in which the proportion of the area occupied by the main subject is to be less than 1.5 times the proportion before the trimming, on the trimming target image 52T as in the first embodiment (step ST230). On the other hand, in a case in which the usage probability 80 is less than 50% (NO in step ST220), the automatic trimming unit 77 determines to perform fourth trimming in which the proportion of the area occupied by the main subject is increased to be equal to or more than 1.5 times the proportion before the trimming, on the trimming target image 52T, instead of determining the trimming method in accordance with the determination rule 39 (step ST240). The third trimming is the same as the first trimming in the first embodiment, and the fourth trimming is the same as the second trimming in the first embodiment. Here, 90% is an example of a “fourth threshold” according to the technology of the present disclosure. In addition, 50% is an example of a “fifth threshold” according to the technology of the present disclosure. In addition, 1.5 times is an example of a “sixth threshold multiple” according to the technology of the present disclosure. It should be noted that, instead of or in addition to the usage probability 80, the shortlist probability 106 described in Modification Example 1 may be used.

As described above, in the second embodiment, in a case in which the usage probability 80 is equal to or more than 90%, the automatic trimming unit 77 determines not to trim the trimming target image 52T. In a case in which the usage probability 80 is equal to or more than 50% and less than 90%, the automatic trimming unit 77 determines to perform the third trimming (first trimming) in which the proportion of the area occupied by the main subject is to be less than 1.5 times the proportion before the trimming. In a case in which the usage probability 80 is less than 50%, the automatic trimming unit 77 determines to perform the fourth trimming (second trimming) in which the proportion of the area occupied by the main subject is increased to be equal to or more than 1.5 times the proportion before the trimming. Therefore, as in the first embodiment, trimming can be performed by an appropriate trimming method in accordance with the usage probability 80, and the satisfaction level of the user U with respect to the automatic trimming processing can be increased.

### Third Embodiment

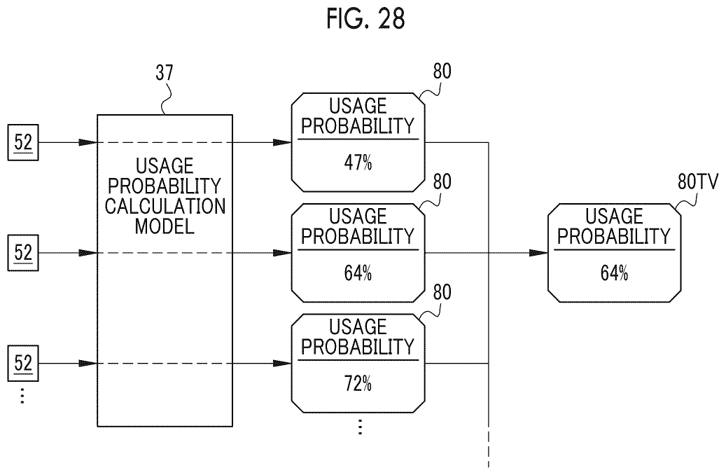

In each of the above-described embodiments, the automatic trimming unit 77 calculates only the usage probability 80 of the trimming target image 52T, but the present disclosure is not limited to this. As shown in FIG. 28 as an example, the automatic trimming unit 77 may calculate the usage probabilities 80 from the plurality of images 52 by using the usage probability calculation model 37, and determine the trimming method of the trimming target image 52T based on a representative usage probability 80TV of a plurality of the usage probabilities 80 calculated from the plurality of images 52. In this case, one of the plurality of images 52 is the trimming target image 52T. One of the plurality of images, which is the trimming target images 52T, is an example of a “related image” according to the technology of the present disclosure.

The plurality of images 52 for which the usage probability 80 is calculated are images belonging to the user U of the user ID included in the automatic trimming request 70. Here, the “belonging image” is, for example, all the images 52 stored in the storage area 50 of the user U of the user ID included in the automatic trimming request 70. The image 52 stored in the storage area 50 includes not only the image 52 captured by the user U using the camera function of the user terminal 10 but also the image 52 given to the user U from the family, the friend, or the like, the image 52 downloaded by the user U through the Internet or the like, and the like. All of these images 52 are collectively treated as the “belonging image”. It goes without saying that the image 52 that is given to the user U from the family, the friend, or the like and the image 52 that is downloaded by the user U through the Internet or the like may be excluded, and only the image 52 captured by the user U using the camera function of the user terminal 10 may be treated as the “belonging image”. The user U of the user ID included in the automatic trimming request 70 is an example of a “designated user” according to the technology of the present disclosure.

The representative usage probability 80TV is, for example, an average value, a most frequent value, a median value, or the like of the plurality of usage probabilities 80. The representative usage probability 80TV is an example of a “representative value” according to the technology of the present disclosure. In FIG. 28, for convenience of description, the plurality of images 52 are drawn to be input at once to the usage probability calculation model 37, and the plurality of usage probabilities 80 are drawn to be output at once from the usage probability calculation model 37, but, in practice, the images 52 are input one by one to the usage probability calculation model 37, and the usage probabilities 80 are output one by one from the usage probability calculation model 37. It should be noted that, instead of or in addition to the usage probability 80, the shortlist probability 106 described in Modification Example 1 may be calculated for the plurality of images 52, and a representative shortlist probability of a plurality of the shortlist probabilities 106 may be calculated.

As described above, in the third embodiment, the usage probability 80 is obtained from the plurality of images 52 belonging to the designated user U, and the trimming method of the trimming target image 52T is determined based on the representative usage probability 80TV of the plurality of usage probabilities 80 obtained from the plurality of images 52. The representative usage probability 80TV has higher reliability that reflects preference of the user U than the usage probability 80 calculated only from the trimming target image 52T. Therefore, it is possible to suggest a trimming method that more matches the preference of the user U.

### Fourth Embodiment

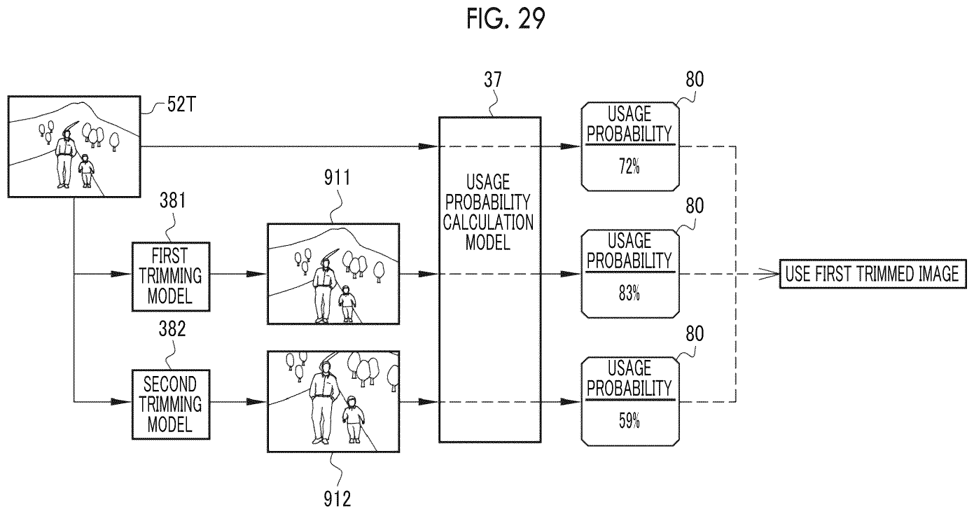

As shown in FIG. 29 as an example, in the fourth embodiment, the automatic trimming unit 77 inputs the trimming target image 52T to the first trimming model 381 and outputs the first trimmed image 911 from the first trimming model 381. Further, the automatic trimming unit 77 inputs the trimming target image 52T to the second trimming model 382 and outputs the second trimmed image 912 from the second trimming model 382. The automatic trimming unit 77 inputs the trimming target image 52T, the first trimmed image 911, and the second trimmed image 912 to the usage probability calculation model 37, and outputs the usage probability 80 of each of the trimming target image 52T, the first trimmed image 911, and the second trimmed image 912 from the usage probability calculation model 37. The automatic trimming unit 77 uses the image having the highest value among the calculated usage probabilities 80. In FIG. 29, a case is shown in which the first trimmed image 911 is used since the usage probability 80 of the trimming target image 52T itself is 72%, the usage probability 80 of the first trimmed image 911 is 83%, and the usage probability 80 of the second trimmed image 912 is 59%.

In FIG. 29, as in the case of FIG. 28, for convenience of description, the trimming target image 52T, the first trimmed image 911, and the second trimmed image 912 are drawn to be input at once to the usage probability calculation model 37, and the plurality of usage probabilities 80 are drawn to be output at once from the usage probability calculation model 37, but, in practice, the trimming target image 52T, the first trimmed image 911, and the second trimmed image 912 are input one by one to the usage probability calculation model 37, and the usage probability 80 is output one by one from the usage probability calculation model 37. It should be noted that, instead of or in addition to the usage probability 80, the shortlist probability 106 described in Modification Example 1 may be used.

As described above, in the fourth embodiment, the image of which the usage probability 80 is the highest among the trimming target image 52T, the first trimmed image 911, and the second trimmed image 912 is used. Therefore, it is possible to suggest a trimming method that is likely to be used in the photo album.

### Fifth Embodiment

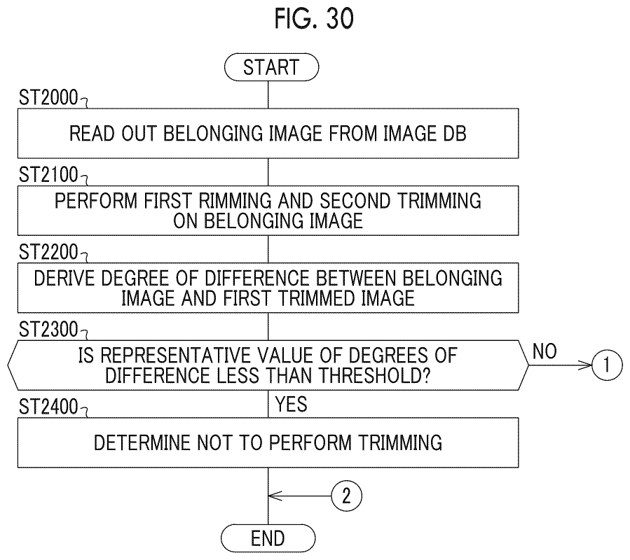

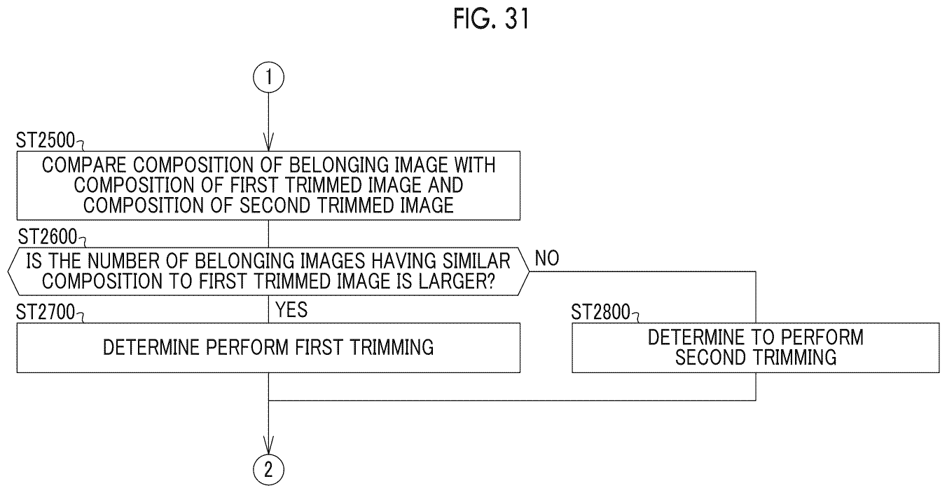

In the fifth embodiment, as an example, the trimming method is determined by procedures shown in flowcharts of FIGS. 30 and 31. First, the RW control unit 47 reads out the image 52 (hereinafter, referred to as a belonging image 52AT) belonging to the user U of the user ID included in the automatic trimming request 70 from the image DB 36 (step ST2000 in FIG. 30). The RW control unit 47 outputs the read-out belonging image 52AT to the image editing unit 46.

The automatic trimming unit 77 inputs the belonging image 52AT to the first trimming model 381 and the second trimming model 382, and performs the first trimming and the second trimming on the belonging image 52AT (step ST2100). Next, the automatic trimming unit 77 derives a degree of difference between the belonging image 52AT and the first trimmed image 911 generated by performing the first trimming on the belonging image 52AT (step ST2200). The degree of difference is derived using a well-known method, such as intersection over union (IoU). The automatic trimming unit 77 calculates a representative value (an average value, a most frequent value, a median value, or the like) of a plurality of the degrees of difference derived for a plurality of the belonging images 52AT.

In a case in which the representative value of the degrees of difference is less than a preset threshold (YES in step ST2300), that is, in a case in which the belonging image 52AT and the first trimmed image 911 are not very different from each other, the automatic trimming unit 77 determines not to trim the trimming target image 52T (step ST2400).

On the other hand, in a case in which the representative value of the degrees of difference is equal to or more than the threshold (NO in step ST2300), that is, in a case in which the belonging image 52AT and the first trimmed image 911 are relatively different from each other, the automatic trimming unit 77 compares the composition of the belonging image 52AT with the composition of the first trimmed image 911 and the composition of the second trimmed image 912 (step ST2500 in FIG. 31). Through this comparison, in a case in which the number of the belonging images 52AT having a similar composition to the first trimmed image 911 is larger (YES in step ST2600), the automatic trimming unit 77 determines to perform the first trimming on the trimming target image 52T (step ST2700). On the other hand, in a case in which the number of the belonging images 52AT having a similar composition to the second trimmed image 912 is larger (NO in step ST2600), the automatic trimming unit 77 determines to perform the second trimming on the trimming target image 52T (step ST2800).

As described above, in the fifth embodiment, a degree of difference between the belonging image 52AT and the first trimmed image 911 is derived, and the trimming method is determined in accordance with the degree of difference. Specifically, in a case in which the representative value of the degrees of difference is less than the threshold, the automatic trimming unit 77 determines not to trim the trimming target image 52T. In a case in which the representative value of the degrees of difference is equal to or more than the threshold and the number of the belonging images 52AT having a similar composition to the first trimmed image 911 is larger, the automatic trimming unit 77 determines to perform the first trimming on the trimming target image 52T. In addition, in a case in which the representative value of the degrees of difference is equal to or more than the threshold and the number of the belonging images 52AT having a similar composition to the second trimmed image 912 is larger, the automatic trimming unit 77 determines to perform the second trimming on the trimming target image 52T. Therefore, it is possible to suggest a trimming method that is more preferred by the user U.

The first threshold to the sixth threshold are not limited to the values described above. For example, the first threshold may be set to 95% and the second threshold may be set to 75%. Alternatively, the third threshold may be 2 instead of 1.5 described as an example.

The evaluation value for the quality of the image may be obtained by taking into account at least one of an image quality of the trimming target image 52T (a numerical value derived in accordance with whether or not the image is properly exposed, whether or not the image is in focus, and the like), the number of persons shown in the trimming target image 52T, the number of faces of the persons shown in the trimming target image 52T, a proportion of an area occupied by the face of the person shown in the trimming target image 52T, or a representative value (sum, average value, or the like) of a degree of smiling of the face of the person shown in the trimming target image 52T.

The image management server 12 may perform all or a part of the functions of the browser control unit 32 of the user terminal 10. Specifically, the image management server 12 generates various screens such as the image editing screen 65 and the automatic trimming result display screen 100, and distributes and outputs the screens to the user terminal 10 in a format of web distribution screen data created by a markup language, such as extensible markup language (XML). In this case, the browser control unit 32 of the user terminal 10 represents various screens to be displayed on the web browser based on the screen data, and displays various screens on the display 24A. Another data description language such as Javascript (registered trademark) object notation (JSON) may be used instead of the XML.

A hardware configuration of the computer constituting the image management server 12 can be modified in various ways. For example, the image management server 12 may be configured by a plurality of separate computers as hardware in order to improve processing capacity and reliability. For example, the functions of the request reception unit 45 and the image editing unit 46 and the functions of the RW control unit 47 and the distribution control unit 48 are distributed to two computers. In this case, the image management server 12 is configured by two computers. In addition, all or a part of the functions of the image management server 12 may be assigned to the user terminal 10.

In this way, the hardware configuration of the computers of the user terminal 10 and image management server 12 can be changed as appropriate depending on the required performance, such as processing capacity, safety, and reliability. Further, it goes without saying that, in addition to the hardware, the APs, such as the image AP 30 and the operation program 35, can also be duplicated or distributed and stored in a plurality of storages for the purpose of securing the safety and the reliability.

In each of the above-described embodiments, for example, the following various processors can be used as a hardware structure of processing units that execute various types of processing, such as the browser control unit 32, the request reception unit 45, the image editing unit 46 (the brightness adjustment unit 75, the effect unit 76, the automatic trimming unit 77, the album creation unit 78, and the like), the RW control unit 47, and the distribution control unit 48. The various processors include, for example, the CPUs 22A and 22B which are general-purpose processors executing software (the image AP 30 and the operation program 35) to function as various processing units, a programmable logic device (PLD), such as a field programmable gate array (FPGA), which is a processor whose circuit configuration can be changed after manufacture, and/or a dedicated electric circuit, such as an application specific integrated circuit (ASIC), which is a processor having a dedicated circuit configuration designed to execute specific processing.

One processing unit may be configured by one of these various processors, or may be configured by a combination of two or more processors of the same type or different types (for example, a combination of a plurality of FPGAs and/or a combination of a CPU and an FPGA). Moreover, a plurality of processing units may be configured by one processor.

As an example in which the plurality of processing units are configured by one processor, first, as represented by a computer, such as a client and a server, there is a form in which one processor is configured by a combination of one or more CPUs and software, and the processor functions as the plurality of processing units. Second, as represented by a system on a chip (SoC) or the like, there is a form in which a processor, which implements the functions of the entire system including the plurality of processing units with a single integrated circuit (IC) chip, is used. As described above, as the hardware structure, the various processing units are configured by one or more of the various processors described above.

Further, more specifically, an electric circuit (circuitry) in which circuit elements such as semiconductor elements are combined can be used as the hardware structure of the various processors.

The technology according to the following supplementary notes can be understood based on the above description.

### Supplementary Note 1

An image processing device comprising: a processor, in which the processor is configured to: obtain an evaluation value for a quality of an image; and determine a trimming method of a trimming target image, which is any one of the image or a related image of the image, based on the evaluation value.

### Supplementary Note 2

The image processing device according to supplementary note 1, in which the processor is configured to: use a machine learning model that outputs the evaluation value in response to input of the image.

### Supplementary Note 3

The image processing device according to supplementary note 2, in which the machine learning model has been trained using a plurality of training data composed of a set of the image and the evaluation value given by a user for the image.

### Supplementary Note 4

The image processing device according to any one of supplementary notes 1 to 3, in which the processor is configured to: acquire at least one of attribute information of a user who owns the trimming target image, accessory information of the trimming target image, or specification information of a photo album created using the trimming target image; and determine the trimming method of the trimming target image based on at least one of the attribute information, the accessory information, or the specification information, in addition to the evaluation value.

### Supplementary Note 5

The image processing device according to supplementary note 4, in which the processor is configured to: determine not to trim the trimming target image in a case in which the evaluation value is equal to or more than a first threshold; determine to perform first trimming in which a proportion of an area occupied by a main subject is to be less than a third threshold multiple of a proportion before trimming in a case in which the evaluation value is equal to or more than a second threshold and less than the first threshold; and determine the trimming method based on at least one of the attribute information, the accessory information, or the specification information in a case in which the evaluation value is less than the second threshold.

### Supplementary Note 6

The image processing device according to supplementary note 5, in which the processor is configured to: determine to perform any one of the first trimming or second trimming in which the proportion is increased to be equal to or more than the third threshold multiple of the proportion before trimming in accordance with at least one of the attribute information, the accessory information, or the specification information in a case in which the evaluation value is less than the second threshold.

### Supplementary Note 7

The image processing device according to any one of supplementary notes 1 to 3, in which the processor is configured to: determine not to trim the trimming target image in a case in which the evaluation value is equal to or more than a fourth threshold; determine to perform third trimming in which a proportion of an area occupied by a main subject is to be less than a sixth threshold multiple of a proportion before trimming in a case in which the evaluation value is equal to or more than a fifth threshold and less than the fourth threshold; and determine to perform fourth trimming in which the proportion is increased to be equal to or more than the sixth threshold multiple of the proportion before trimming in a case in which the evaluation value is less than the fifth threshold.

### Supplementary Note 8

The image processing device according to any one of supplementary notes 1 to 7, in which the image is a plurality of images belonging to a designated user, the related image, which is the trimming target image, is one of the plurality of images, and the processor is configured to: obtain the evaluation values from the plurality of images; and determine the trimming method of the trimming target image based on a representative value of a plurality of the evaluation values obtained from the plurality of images.

The technology of the present disclosure can also be combined with various embodiments and/or various modification examples described above, as appropriate. In addition, it goes without saying that the present disclosure is not limited to each of the embodiments described above, various configurations can be adopted as long as the configuration does not deviate from the gist. Further, the technology of the present disclosure includes a storage medium that stores the program in a non-transitory manner, in addition to the program.

The above-described contents and the above-shown contents are the detailed description of the parts according to the technology of the present disclosure, and are merely an example of the technology of the present disclosure. For example, the above description of the configuration, the function, the operation, and the effect are the description of examples of the configuration, the function, the operation, and the effect of the parts according to the technology of the present disclosure. Accordingly, it goes without saying that unnecessary parts may be deleted, new elements may be added, or replacements may be made with respect to the above-described contents and the above-shown contents within a range that does not deviate from the gist of the technology of the present disclosure. In addition, in order to avoid complications and facilitate grasping the parts according to the technology of the present disclosure, in the above-described contents and the above-shown contents, the description of technical general knowledge and the like that do not particularly require description for enabling the implementation of the technology of the present disclosure are omitted.

In the present specification, “A and/or B” has the same meaning as “at least one of A or B”. That is, “A and/or B” means that it may be only A, only B, or a combination of A and B. In addition, in the present specification, also in a case in which three or more matters are expressed in association by “and/or”, the same concept as “A and/or B” is applied.

All of the documents, the patent applications, and the technical standards described in the present specification are incorporated herein by reference to the same extent as in a case in which each of the documents, patent applications, and technical standards is specifically and individually described by being incorporated by reference.

What is claimed is:

1. An image processing device comprising:
a processor,
wherein the processor is configured to:
obtain an evaluation value for a quality of an image; and
determine a trimming method of a trimming target image, which is any one of the image or a related image of the image, based on the evaluation value.

2. The image processing device according to claim 1,
wherein the processor is configured to:
use a machine learning model that outputs the evaluation value in response to input of the image.

3. The image processing device according to claim 2,
wherein the machine learning model has been trained using a plurality of training data composed of a set of the image and the evaluation value given by a user for the image.

4. The image processing device according to claim 1,
wherein the processor is configured to:
acquire at least one of attribute information of a user who owns the trimming target image, accessory information of the trimming target image, or specification information of a photo album created using the trimming target image; and
determine the trimming method of the trimming target image based on at least one of the attribute information, the accessory information, or the specification information, in addition to the evaluation value.

5. The image processing device according to claim 4,
wherein the processor is configured to:
determine not to trim the trimming target image in a case in which the evaluation value is equal to or more than a first threshold;
determine to perform first trimming in which a proportion of an area occupied by a main subject is to be less than a third threshold multiple of a proportion before trimming in a case in which the evaluation value is equal to or more than a second threshold and less than the first threshold; and
determine the trimming method based on at least one of the attribute information, the accessory information, or the specification information in a case in which the evaluation value is less than the second threshold.

6. The image processing device according to claim 5,
wherein the processor is configured to:
determine to perform any one of the first trimming or second trimming in which the proportion is increased to be equal to or more than the third threshold multiple of the proportion before trimming in accordance with at least one of the attribute information, the accessory information, or the specification information in a case in which the evaluation value is less than the second threshold.

7. The image processing device according to claim 1,
wherein the processor is configured to:
determine not to trim the trimming target image in a case in which the evaluation value is equal to or more than a fourth threshold;
determine to perform third trimming in which a proportion of an area occupied by a main subject is to be less than a sixth threshold multiple of a proportion before trimming in a case in which the evaluation value is equal to or more than a fifth threshold and less than the fourth threshold; and
determine to perform fourth trimming in which the proportion is increased to be equal to or more than the sixth threshold multiple of the proportion before trimming in a case in which the evaluation value is less than the fifth threshold.

8. The image processing device according to claim 1,
wherein the image is a plurality of images belonging to a designated user,
the related image, which is the trimming target image, is one of the plurality of images, and
the processor is configured to:
obtain the evaluation values from the plurality of images; and
determine the trimming method of the trimming target image based on a representative value of a plurality of the evaluation values obtained from the plurality of images.

9. An operation method of an image processing device, the operation method comprising:
obtaining an evaluation value for a quality of an image; and
determining a trimming method of a trimming target image, which is any one of the image or a related image of the image, based on the evaluation value.

10. A non-transitory computer-readable storage medium storing an operation program of an image processing device, the operation program causing a computer to execute a process comprising:
obtaining an evaluation value for a quality of an image; and
determining a trimming method of a trimming target image, which is any one of the image or a related image of the image, based on the evaluation value.
